(19) United States
(12) Patent Application Publication
(10) Pub. No.: US 2025/0001446 A1
(43) Pub. Date: Jan. 2, 2025

(54) Spray Shield Holder Having Clips for Selective Retention of Spray-Shielding Substrates

(71) Applicant: Hyde Tools, Inc., Southbridge, MA (US)

(72) Inventors: Richard M. Farland, Fiskdale, MA (US); Alexandre Huneau, Laval (CA); Christian Michaud, St-Ignace-de-Loyola (CA); Corey Talbot, Hebron, CT (US)

(21) Appl. No.: 18/652,033

(22) Filed: May 1, 2024

Related U.S. Application Data
(63) Continuation of application No. PCT/US2023/082891, filed on Dec. 7, 2023.
(60) Provisional application No. 63/433,937, filed on Dec. 20, 2022.

(51) Int. Cl. B05B 12/32

(52) U.S. Cl. CPC B05B 12/32

(57) ABSTRACT

A spray shield holder includes a platform having opposed first and second spray-shield mounting surfaces coextending between a platform proximate edge and a platform distal edge forward of the proximate edge. A forward-facing central clip depends from the first spray-shield mounting surface. Depending from the second spray-shield mounting surface are lateral first and second clips mutually situated on opposite sides—and laterally to the outside—of the central clip. While each of the lateral first and second clips faces laterally, and is oriented orthogonally to the central clip, the lateral first and second clips face oppositely of one another. The central clip is flexibly configured for removably retaining a central spray shield between itself and the first spray-shield mounting surface, while each of the lateral first and second clips is configured for removably retaining, respectively, a first and second spray shield between itself and the second spray-shield mounting surface.

### CROSS-REFERENCE TO RELATED APPLICATIONS/PRIORITY CLAIMS

The present application is a continuation application of International Application Serial No. PCT/US2023/082891 filed Dec. 7, 2023 pursuant to the Patent Cooperation Treaty, and under the title “SPRAY SHIELD HOLDER HAVING CLIPS FOR SELECTIVE RETENTION OF SPRAY-SHIELDING SUBSTRATES.” Application PCT/US2023/082891 claimed priority benefits in U.S. Provisional Application No. 63/433,937 filed Dec. 20, 2022 under the title “SPRAY SHIELD HOLDER HAVING CLIPS FOR SELECTIVE RETENTION OF SPRAY-SHIELDING SUBSTRATES.”

The present application claims the benefit of the filing date of Provisional Application Ser. No. 63/433,937, as well as the filing date of PCT Application No. PCT/US2023/082891, based on the priority chain outlined above. Moreover, the entireties of the disclosures, including the drawings, of both previous applications in the aforesaid priority chain are incorporated herein by reference as if set forth fully in the present application.

### BACKGROUND

When spraying liquid coatings such as paint and clearcoats onto surfaces such as walls, floors, and ceilings, the need arises to mask surfaces upon which contact by the sprayed liquid coating is not desired. Masking is achieved through the use of various products and methods including, for example, painter's tape and spray shields.

Variously configured spray shields are available on the market. In broad terms, most spray shields are either comprised of permanent (non-disposable) components or are entirely disposable. Moreover, the existing products of either type generally provide a single rectangular spray-shielding substrate that does not protect against overspray to areas surrounding a surface to be coated.

Accordingly, a need exists for a spray shield holder by which multiple spray shields can be selectively retained in arrangements that shield larger areas in configurations not readily achievable with a single rectangular spray shield.

### SUMMARY

Illustratively embodied, a spray shield holder includes a substantially rectangular platform defining opposed first and second spray-shield mounting surfaces. The first and second spray-shield mounting surfaces coextend between a platform proximate edge by which the platform can be held by a user, either directly or through an attached handle; a platform distal edge forward of the proximate edge; and platform lateral first and second edges that extend between the platform proximate and distal edges. The first and second spray-shield mounting surfaces furthermore define, respectively, first and second spray-shield mounting planes along which each mounting surface extends. The platform is most commonly configured such that first and second spray-shield mounting planes are mutually parallel, with the distance between them defining or otherwise bearing a relationship to the thickness of the platform. For purposes of consistent spatial and directional orientation, unless otherwise noted, relative terms such as “rearward of,” “forward of,” “proximate,” “distal,” “upward,” “downward,” “above,” “below,” “top,” and “bottom,” and variants and synonyms of each of these, are defined with respect to the expected relative positioning of the spray shield and its user when in normal use. However, in more “self-contained” and universally applicable terms that do not depend upon the presence or placement of external objects such as a user, the platform proximate edge is generally regarded as rearward of the platform distal edge, and the first spray-shield mounting surface is regarded as the top surface of the platform that is above the second (bottom) spray-shield mounting surface situated below the first spray-shield mounting surface, irrespective of how a user grasps the spray shield holder at any given time, or if anyone is holding it at all.

In each instance of various configurations, the spray shield holder includes a central clip carried by the platform, and, in various embodiments, depending and extending upwardly—at least in part—from the first spray-shield mounting surface. The central clip has a central-clip rearward end by which the central clip depends from the platform and a central-clip forward end opposite and forward of the rearward end (i.e., closer to the distal edge of the platform than is the central-clip rearward end). Lateral central-clip first and second edges extend between the central-clip rearward and forward ends. The central-clip forward end and the first and second edges are free from the platform (i.e., not attached to the platform) such that the central-clip forward end can be selectively displaced toward and away from the first spray-shield mounting plane in order to accommodate the removable retention of a central spray-shielding substrate between the central clip and the first spray-shield mounting surface. Illustratively, but non-limitingly, the manner by which the central clip depends from the platform by its rearward end is either (i) through attachment by at least one of adhesive, fasteners such as rivets, or spot welding or (ii) integral fabrication, such as by injection molding, for instance.

The central-clip forward end is normally mechanically biased toward the first mounting plane such that a central spray-shielding substrate introduced between the central clip and the first spray-shield mounting surface is retained therebetween by action of the central-clip forward end's contacting engagement with the central spray-shielding substrate and mechanical bias toward the first spray-shield mounting surface. “Normally” in this context—and in other, similar contexts—denotes “usually” or “by default,” and not orthogonally. The mechanical biasing action is provided by a central-clip biasing member that selectively exerts a central-clip biasing force. In each of various configurations, the central clip itself serves as its own biasing member. More specifically, the central clip is fabricated from a resilient material with a “memory property” and default configuration (i.e., shape) from which it can be flexedly deformed, through application of an external flexing force, in a direction away from the platform, and in opposition to the biasing force that the clip exerts by virtue of its deformation from its default configuration. In some cases, a user uses his or her fingers to deform the clip and facilitate introduction of the central spray-shielding substrate while, in other cases, the central-clip forward end curves away from the first spray-shield mounting plane in a manner that facilitates a user's direct insertion of the central spray-shielding substrate between the central clip and the first spray-shield mounting surface. In the latter instance, the act of inserting the central spray-shielding substrate itself deforms the central clip from its default configuration.

In addition to the central clip, various embodiments further include at least a lateral first clip situated between the central clip and the lateral first edge of the platform. In various embodiments, and in a manner limitedly analogous to the that of the central clip, the lateral first clip is carried by the platform such that it depends and extends downwardly—at least in part—form the second spray-shield mounting surface. The lateral first clip has a first-clip fixed end by which it depends from the platform, a first-clip free end laterally opposite the fixed end and situated between the first-clip fixed end and the lateral first edge of the platform. First-clip front and rear edges extend between the first-clip fixed and free ends. The first-clip free end and front and rear edges are free from the platform such that the first-clip free end can be selectively displaced toward and away from the second spray-shield mounting plane in order to accommodate the removable retention of a first spray-shielding substrate between the first clip and the second spray-shield mounting surface. The manner by which the first clip depends from the platform at the first-clip fixed end may be by any of the same methods, devices, or structures through which the central clip depends from the platform.

The first-clip free end is normally mechanically biased toward the second mounting plane such that a first spray-shielding substrate introduced between the first clip and the second spray-shield mounting surface is retained therebetween by action of the first-clip free end's contacting engagement with the first spray-shielding substrate and mechanical bias toward the second spray-shield mounting surface. The mechanical biasing action is provided by a first-clip biasing member that selectively exerts a first-clip biasing force. In a manner analogous to that described relative the central clip, the first clip may be configured to serve as its own first-clip biasing member. Moreover, it may also be configured in a manner that facilitates direct insertion of the first spray-shielding substrate between the first clip and the second spray-shield mounting surface. In the latter instance, as with the central clip, the act of inserting the first spray-shielding substrate itself deforms the first clip from its default configuration, and removal of the spray-shielding substrate allows the first clip to return to its default configuration.

Still-additional embodiments that include a central and lateral first clip further include a lateral second clip situated between the central clip and the lateral second edge of the platform. In various embodiments, and in a manner analogous to the that of the lateral first clip, the lateral second clip is carried by the platform such that it depends and extends downwardly—at least in part—form the second spray-shield mounting surface. The second clip has a second-clip fixed end by which it depends from the platform and a second-clip free end laterally opposite the fixed end and situated between the fixed end and the lateral second edge of the platform. Second-clip front and rear edges extend between the second-clip fixed and free ends. The second-clip free end and front and rear edges are free from the platform such that the second-clip free end can be selectively displaced toward and away from the second spray-shield mounting plane in order to accommodate the removable retention of a second spray-shielding substrate between the second clip and the second spray-shield mounting surface. The manner by which the second clip depends from the platform at the second-clip fixed end may be by any of the same methods, devices, or structures through which the central clip and/or the lateral first clip depends from the platform. For purposes of simplification, a “spray-shielding substrate” may be alternatively and interchangeably referred to as a “spray shield” further in the present specification and the claims appended hereto.

The second-clip free end is normally mechanically biased toward the second mounting plane such that a second spray shield introduced between the second clip and the second spray-shield mounting surface is retained therebetween by action of the second-clip free end's contacting engagement with the second spray shield and mechanical bias toward the second spray-shield mounting surface. The mechanical biasing action is provided by a second-clip biasing member that selectively exerts a second-clip biasing force. In a manner analogous to that described relative the central clip and the lateral first clip, the lateral second clip may be configured to serve as its own second-clip biasing member. Moreover, the second clip may also be configured in a manner that facilitates direct insertion of the second spray shield between the second clip and the second spray-shield mounting surface. In the latter instance, as with the central and lateral first clip, the act of inserting the second spray shield itself deforms the second clip from its default configuration, and removal of the second spray shield allows the second clip to return to its default configuration.

According to one configuration in which the platform is substantially rectangular, the central-clip forward end extends substantially parallel to the platform distal edge, while the first-clip and second-clip free ends extend substantially orthogonal to the platform distal edge. In this way, the first-clip and second-clip free ends extend substantially to parallel one another and substantially perpendicular to the central-clip forward end. The aforesaid configuration facilitates all three of: (i) the rearwardly-directed insertion of the central spray shield over the platform distal end toward the platform proximate end for positioning and retention between the central clip and the first spray-shield mounting surface; (ii) the laterally-directed insertion of the first spray shield over the lateral first edge of the platform toward the central clip for positioning and retention between the first clip and the second spray-shield mounting surface; and (iii) the laterally-directed insertion of the second spray shield over the lateral second edge of the platform toward the central clip for positioning and retention between the second clip and the second spray-shield mounting surface. Given these orientations, the central clip can be regarded as forwardly facing, while each of the lateral first and second clips can be regarded as laterally facing or side facing. Moreover, and more generally, the lateral first and second clips can be regarded as oppositely facing relative to one another and oriented orthogonally to the central clip on mutually opposite lateral sides of the central clip.

In alternative implementations, the various spray shields may be reusable, disposable, and/or recyclable. In any case, the spray-shielding substrates should be substantially self-supporting, even if flexible. Reusable spray shields are preferably fabricated from a material that lends itself to cleaning, such as sheet metal (e.g., aluminum or steel) or a polymeric material like plastic. Disposable spray shields are illustratively fabricated from a paper-based material, such as cardstock or cardboard. Alternative to either of the aforesaid options, spray shields could be configured for several uses before disposal or recycling.

As alluded to in the opening paragraph of the summary, the spray shield holder may be alternatively configured for direct holding of the platform in the hand of a user or indirect holding by means of an attached handle. The handle may be in the form of a pole having handle proximate and distal ends. In one such embodiment, the spray shield holder includes a handle coupling that facilitates removable attachment of a handle. According to one version, the handle coupling advantageously depends from the proximate edge of the platform from where it extends rearwardly of the platform and facilitates pivotal motion of the platform relative to the handle about at least a first pivot axis. In alternative versions, the handle coupling further facilitates pivotal motion about at least a second pivot axis the extends orthogonally to the first pivot axis. In a still-additional version, a universal coupling, such as a ball-and-socket joint, facilitates infinite orientation of the handle relative to the platform over a range of angles.

Representative embodiments are more completely described and depicted in the following detailed description and the accompanying drawings.

### BRIEF DESCRIPTION OF THE DRAWINGS

FIG. 1 is a top perspective view of a spray shield holder including a platform with clips for selectively retaining spray-shielding substrates, and configured for connecting to a handle;

FIG. 2 is a top elevation view of the spray shield holder of FIG. 1;

FIG. 3 is a bottom elevation view of the spray shield holder of FIGS. 1 and 2;

FIG. 4 is a side elevation view of the spray shield holder of FIGS. 1-3;

FIG. 5 is a top elevation view of the spray shield holder of FIGS. 1-4 indicating the manner in which spray-shielding substrates are introduced between the platform and the clips for removable retention; and

FIG. 6 depicts the spray shield holder of FIGS. 1-5 pivotably attached to an elongated handle.

### DETAILED DESCRIPTION

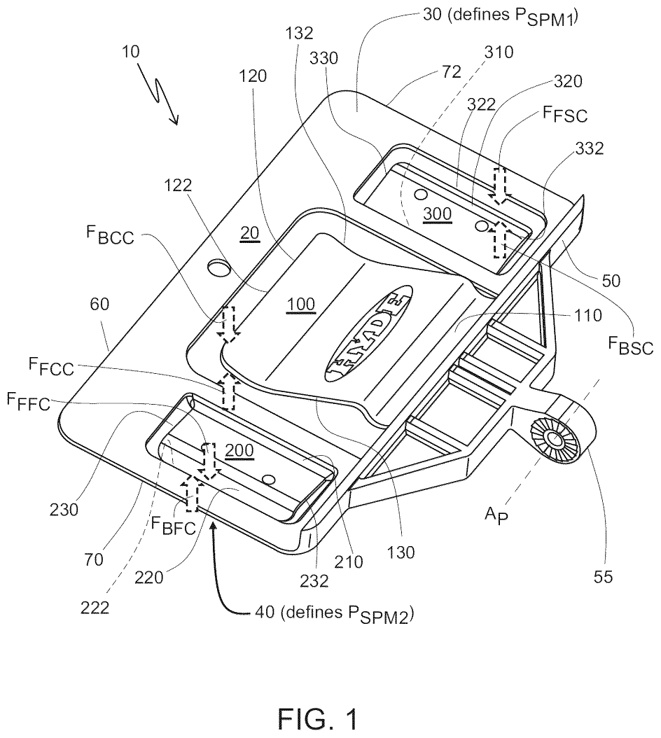

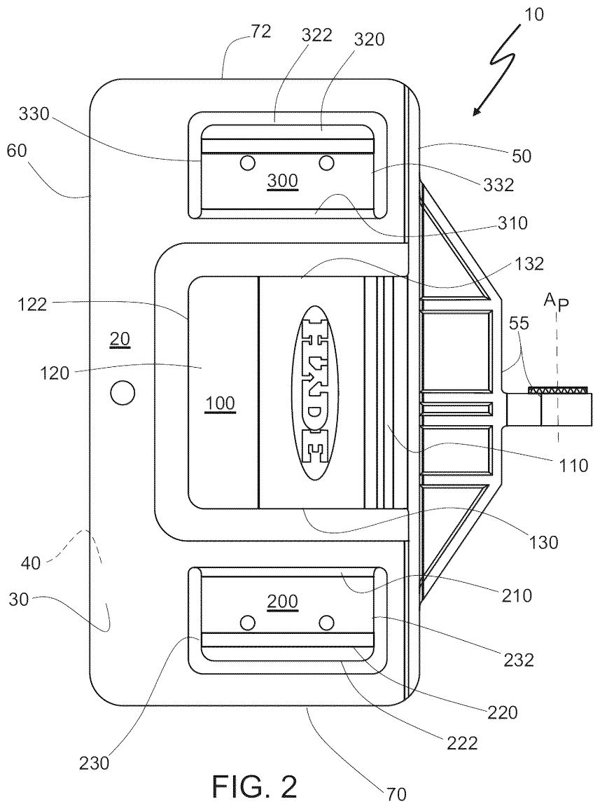

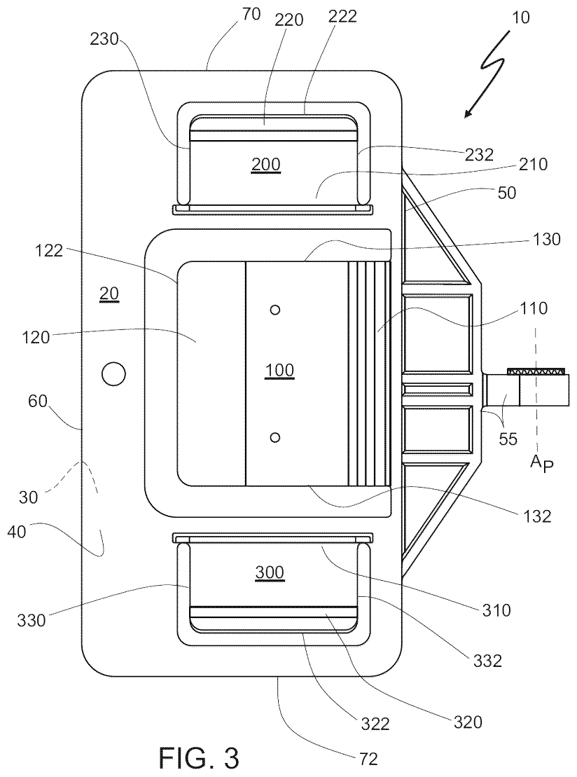

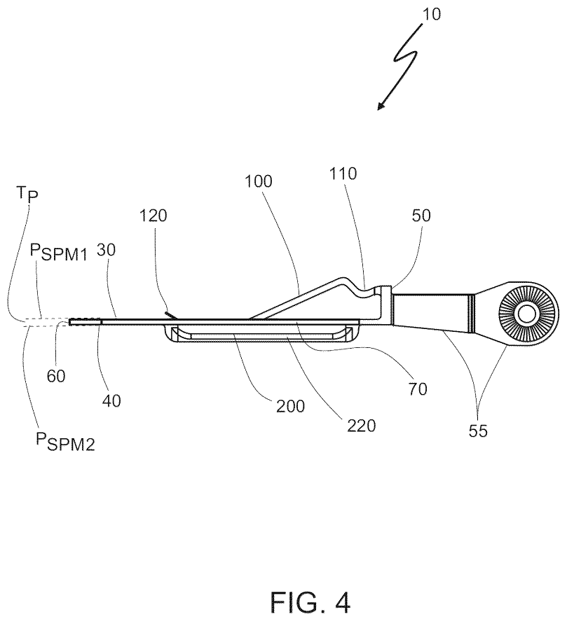

The following description of variously embodied spray shield holders is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims. Moreover, among the various depicted embodiments, like reference numbers are used to refer to similar or analogous components. Referring initially to FIGS. 1-3, an illustratively embodied spray shield holder 10 includes a substantially rectangular platform 20 defining opposed first and second spray-shield mounting surfaces 30 and 40. The first and second spray-shield mounting surfaces 30 and 40 coextend between a platform proximate edge 50, a platform distal edge 60 forward of the proximate edge, and platform lateral first and second edges 70 and 72 that extend between the platform proximate 50 and distal edges 60. As shown most clearly in the side view of FIG. 4, the first and second spray-shield mounting surfaces 30 and 40 define and extend along, respectively, first and second spray-shield mounting planes P_{SPM1} and P_{SPM2}. In the illustrative embodiment depicted, the platform is configured such that first and second spray-shield mounting planes P_{SPM1} and P_{SPM2} are mutually parallel, with the distance between them defining or otherwise bearing a relationship to the thickness T_{P} of the platform.

While the initial designation of top and bottom surfaces is, in fact, arbitrary, for purposes of conceptualization and spatial orientation in the description, the first and second spray-shield mounting surfaces 30 and 40 are regarded as, respectively, the top and bottom surfaces of the platform 20, and may be alternatively referred to as such using the reference numbers 30 and 40 in either case. Moreover, for purposes of consistent spatial and directional orientation, unless otherwise noted, relative terms such as “rearward of,” “forward of,” “proximate,” “distal,” “upward,” and “downward,” and variants of each, are defined with respect to the expected relative positioning of the spray shield holder 10 and its user when in normal use. However, in more “self-contained” and universally applicable terms that do not depend upon the presence or placement of external objects such as a user, the platform proximate edge 50 is always regarded as rearward of the platform distal edge 60, irrespective of how a user grasps the spray shield holder 10 at any given time, or if anyone is holding it at all.

As shown in all of FIGS. 1-5, the platform 20 carries a central clip 100. The central clip 100 has a central-clip rearward end 110 by which the central clip 100 depends from the platform 20 and a central-clip forward end 120 opposite and forward of the rearward end 110. Lateral central-clip first and second edges 130 and 132 extend between the central-clip rearward and forward ends 110 and 120. The central-clip forward end 120 and the first and second edges 130 and 132 are free of the platform 20 such that the central-clip forward end 120 can be selectively displaced toward and away from the first spray-shield mounting plane P_{SPM1} in order to accommodate the removable retention of a central spray shield 400A between the central clip 100 and the first spray-shield mounting surface 30.

The central-clip forward end 120 is normally mechanically biased toward the first spray-shield mounting plane P_{SPM1} such that a central spray shield 400A introduced between the central clip 100 and the first spray-shield mounting surface 30 is retained therebetween by action of the central-clip forward end 120 contactably engaging the central spray shield 400A and being mechanically biased toward the first spray-shield mounting surface 30. That is, the central spray-shielding substrate 400A is “pinched” between the central clip 100 and the first spray-shield mounting surface 30 by virtue of the fact that a central-clip biasing member provides a central-clip biasing force F_{BCC} that urges the central-clip forward end 120—and, thereby, the central spray-shielding substrate 400A—toward the first spray-shield mounting plane P_{SPM1} defined by the first spray-shield mounting surface 30.

In the embodiment depicted, the central clip 100 itself serves as its own central-clip biasing member, and is therefore not referenced by a distinct reference character in the drawings or the present description. More specifically, the central clip 100 is fabricated from a resilient material with a “memory property” and default configuration from which it can be flexedly deformed. When a central-clip flexing force F_{FCC} is externally applied to the central-clip forward end 120 in a direction away from the platform 20 to create or increase a gap (no shown) between the central-clip forward end 120 and the first spray-shield mounting plane P_{SPM1} defined by the first spray-shield mounting surface 30, the central clip 100 exerts a central-clip biasing force F_{BCC} in opposition to the external flexing force F_{FCC}. When the external flexing force F_{FCC} is reduced or removed, the deformed central clip 100 returns toward its default configuration. In some cases, a user uses his or her fingers to deform the clip and facilitate introduction of the central spray shield 400A. In other cases, such as that depicted most clearly in FIGS. 1, 4, and 5, the central-clip forward end 120, even in its default configuration, curves upwardly and away from the first spray-shield mounting plane P_{SPM1} in a manner that facilitates a user's direct insertion of the central spray shield 400A between the central clip 100 and the first spray-shield mounting surface 30. In the latter instance, the act itself of inserting the central spray shield 400A deforms the central clip 100 from its default configuration and introduces the central-clip biasing force F_{BCC} that retains the central spray shield 400A.

In the illustrative embodiment depicted, the central clip 100 is integrally formed with the platform 20. Integral fabrication may be achieved through a molding process, such as injection molding, with the platform 20 and central clip 100 being comprised of the same material (e.g., plastic). In such as case, the platform 20 is of a thickness and configuration that renders it substantially rigid (i.e., at least sufficiently rigid to be self-supporting) while the central clip 100 includes at least regions along its length that are sufficiently thin to render the central clip 100 flexible in order to function as described. Relative to versions made from a material such as sheet or plate metal, integral fabricating and shaping may be achieved by stamping or pressing process.

With continued reference to FIGS. 1-5, the spray shield holder 10 further includes a lateral first clip 200 situated between the central clip 100 and the lateral first edge 70 of the platform 20. While the configuration of the lateral first clip 200 is generally analogous to that of the central clip 100, its position and orientation on the platform 20 differ. The first clip 200 has a first-clip fixed end 210, by which it depends from the platform 20, and a first-clip free end 220 laterally opposite the fixed end 210 and situated between the first-clip fixed end 210 and the lateral first edge 70 of the platform 20. First-clip front and rear edges 230 and 232 extend between the first-clip fixed and free ends 210 and 220. The first-clip free end 220 and front and rear edges 230 and 232 are free of (e.g., separated by a gap from) the platform 20 such that the first-clip free end 220 can be selectively displaced toward and away from the second spray-shield mounting plane P_{SPM2} in order to accommodate the removable retention of a lateral first spray shield 400B between the first clip 200 and the second spray-shield mounting surface 40. The manner by which the lateral first clip 200 is formed and depends from the platform 20 at the first-clip fixed end 210 may be by any of the same methods, devices, or structures through which the central clip 100 is formed and depends from the platform 20.

The first-clip free end 220 is normally mechanically biased toward the second spray-shield mounting plane P_{SPM2} such that the lateral first spray shield 400B introduced between the first clip 200 and the second spray-shield mounting surface 40 is retained therebetween by action of the first-clip free end 220 contactably engaging the first spray shield 400B and being mechanically biased toward the second spray-shield mounting surface 40. That is, the first spray-shielding substrate 400B is “pinched” between the first clip 200 and the second spray-shield mounting surface 40 by virtue of the fact that a first-clip biasing member provides a first-clip biasing force F_{BFC} that urges the first-clip forward end 220—and, thereby, the first spray-shielding substrate 400B—toward the second spray-shield mounting plane P_{SPM2} defined by the second spray-shield mounting surface 40.

In the embodiment depicted, and in a fashion analogous to that of the central clip 100, the first clip 200 itself serves as its own first-clip biasing member, and is therefore not referenced by a distinct reference character in the drawings or the present description. More specifically, the first clip 200 is fabricated from a resilient material with a “memory property” and default configuration from which it can be flexedly deformed. When a first-clip flexing force F_{FFC} is externally applied to the first-clip free end 220 in a direction away from the platform 20 to create or increase a gap (no shown) between the first-clip free end 220 and the second spray-shield mounting plane P_{SPM2} defined by the second spray-shield mounting surface 40, the first clip 200 exerts a first-clip biasing force F_{BFC} in opposition to the externally-applied first-clip flexing force F_{FFC}. When the external first-clip flexing force F_{FFC} is reduced or removed, the deformed first clip 200 returns toward its default configuration. As with the central clip 100, a user uses his or her fingers to deform the first clip 200 to facilitate introduction of the first spray-shielding substrate 400B. In other cases, such as that depicted most clearly in FIGS. 1, the first-clip free end 220, even in its default configuration, curves downwardly and away from the second spray-shield mounting plane P_{SPM2} in a manner that facilitates a user's direct insertion of the first spray-shielding substrate 400B between the first clip 200 and the second spray-shield mounting surface 40. In the latter instance, the act itself of inserting the first spray shield 400B deforms the first clip 200 from its default configuration and introduces the first-clip biasing force F_{BFC} that retains the first spray-shielding substrate 400B.

In the illustrative embodiment depicted, the first clip 200 is integrally formed with the platform 20. As with the central clip 100, integral fabrication may be achieved through a pressing, stamping, or molding process, such as injection molding, with the platform 20 and first clip 200 being comprised of the same material. In such as case, the first clip 200 includes at least regions along its length that are sufficiently thin to render the first clip 200 flexible so that it can flex and function as described.

In the illustrative embodiment depicted, the spray shield holder 10 still-further includes a lateral second clip 300 situated between the central clip 100 and the lateral second edge 72 of the platform 20. As with the lateral first clip 100, the configuration of the lateral second clip 300 is generally analogous to that of the central clip 100, but its position and orientation on the platform 20 differ from those of the central clip 100. As depicted, the lateral second clip 300 resides on the same side of the platform 20 and is essentially a “mirror image” of the first clip 200 about a plane—not shown, but readily envisioned—bisecting the central clip 100 and extending orthogonally to both the first and second spray-shield mounting planes P_{SPM1} and P_{SPM2} and through the platform proximate and distal edges 50 and 60.

The second clip 300 has a second-clip fixed end 310, by which it depends from the platform 20, and a second-clip free end 320 laterally opposite the fixed end 310 and situated between the second-clip fixed end 310 and the lateral second edge 72 of the platform 20. Second-clip front and rear edges 330 and 332 extend between the second-clip fixed and free ends 310 and 320. The second-clip free end 320 and front and rear edges 330 and 332 are free of (e.g., separated by a gap from) the platform 20 such that the second-clip free end 320 can be selectively displaced toward and away from the second spray-shield mounting plane P_{SPM2} in order to accommodate the removable retention of a lateral second spray-shielding substrate 400C between the second clip 300 and the second spray-shield mounting surface 40. The manner by which the lateral second clip 300 depends from the platform 20 at the second-clip fixed end 210 may be by any of the same methods, devices, or structures through which the central and lateral first clips 100 and 200 depend from the platform 20.

The second-clip free end 320 is normally mechanically biased toward the second spray-shield mounting plane P_{SPM2} such that the lateral second spray shield 400C introduced between the second clip 300 and the second spray-shield mounting surface 40 is retained therebetween by action of the second-clip free end 320 contactably engaging the second spray shield 400C and being mechanically biased toward the second spray-shield mounting surface 40. That is, the second spray-shielding substrate 400C is “pinched” between the second clip 300 and the second spray-shield mounting surface 40 by virtue of the fact that a second-clip biasing member provides a second-clip biasing force F_{BSC} that urges the second-clip forward end 320—and, thereby, the second spray shield 400C—toward the second spray-shield mounting plane P_{SPM2} defined by the second spray-shield mounting surface 40.

In the embodiment depicted, and in a fashion analogous to that of the central and lateral first clips 100 and 200, the second clip 300 itself serves as its own second-clip biasing member, and is therefore not referenced by a distinct reference character in the drawings or the present description. That is, the second clip 300 is fabricated from a resilient material with a “memory property” and default configuration from which it can be flexedly deformed. When a second-clip flexing force F_{FSC} is externally applied to the second-clip free end 320 in a direction away from the platform 20 to create or increase a gap (not shown) between the second-clip free end 320 and the second spray-shield mounting plane P_{SPM2} defined by the second spray-shield mounting surface 40, the second clip 300 exerts a second-clip biasing force F_{BBC} in opposition to the externally-applied second-clip flexing force F_{FSC}. When the second-clip flexing force F_{FSC} is reduced or removed, the deformed second clip 300 returns toward its default configuration. As with the central and first clips 100 and 200, a user of the spray shield holder 10 can use his or her fingers to deform the second clip 300 to facilitate insertion of the second spray shield 400C. In other cases, such as that depicted most clearly in FIGS. 1, the second-clip free end 320, even in its default configuration, curves downwardly and away from the second spray-shield mounting plane P_{SPM2} in a manner that facilitates a user's direct insertion of the second spray-shielding substrate 400C between the second clip 300 and the second spray-shield mounting surface 40. The act itself of inserting the second spray shield 400B deforms the second clip 300 from its default configuration and introduces the second-clip biasing force F_{BSC} that retains the second spray-shielding substrate 400C.

In the illustrative embodiment depicted, the second clip 300 is integrally formed with the platform 20. As with the central and first clips 100 and 200, integral fabrication may be achieved through a stamping, pressing, or molding process, such as injection molding, with the platform 20 and second clip 300 being comprised of the same material. In such as case, the second clip 300 includes at least regions along its length that are sufficiently thin to render the second clip 300 flexible so that it can flex and function as described.

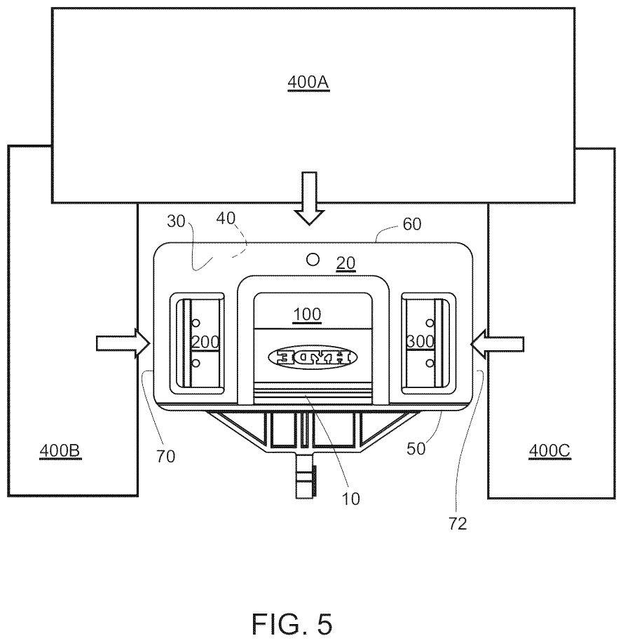

In the illustrative embodiment of FIGS. 1-5, the platform 20 is substantially rectangular, with the platform proximate and distal edges 50 and 60 being substantially parallel to one another and the platform lateral first and second edges 70 and 72 also being substantially to one another, but perpendicular to the platform proximate and distal edges 50 and 60. The central-clip forward end 120 includes a central-clip forward edge 122 that extends substantially parallel to the platform distal edge 60 such that the central-clip forward end 120 overall is regarded as extending substantially parallel to the platform distal edge 60. Distinguishably, the first-clip and second-clip free ends 220 and 320 include, respectively, first-clip and second-clip free edges 222 and 322 that extend substantially orthogonal to the platform distal edge 60. Configured and arranged thusly, the first-clip and second-clip free ends 220 and 320 overall are regarded as extending substantially parallel to one another and substantially perpendicular to the central-clip forward end 120. With conjunctive reference to FIG. 5, one can readily appreciate how the aforesaid arrangement and configuration of the clips 100, 200, and 300 facilitate all three of: (i) the rearwardly-directed insertion of the central spray shield 400A over the platform distal edge 60 toward the platform proximate edge 50 for positioning and retention between the central clip 100 and the first spray-shield mounting surface 30; (ii) the laterally-directed insertion of the first spray shield 400B over the lateral first edge 70 of the platform 20 toward the central clip 100 for positioning and retention between the first clip 200 and the second spray-shield mounting surface 40; and (iii) the laterally-directed insertion of the second spray shield 400C over the lateral second edge 72 of the platform 20 toward the central clip 100 for positioning and retention between the second clip 300 and the second spray-shield mounting surface 40.

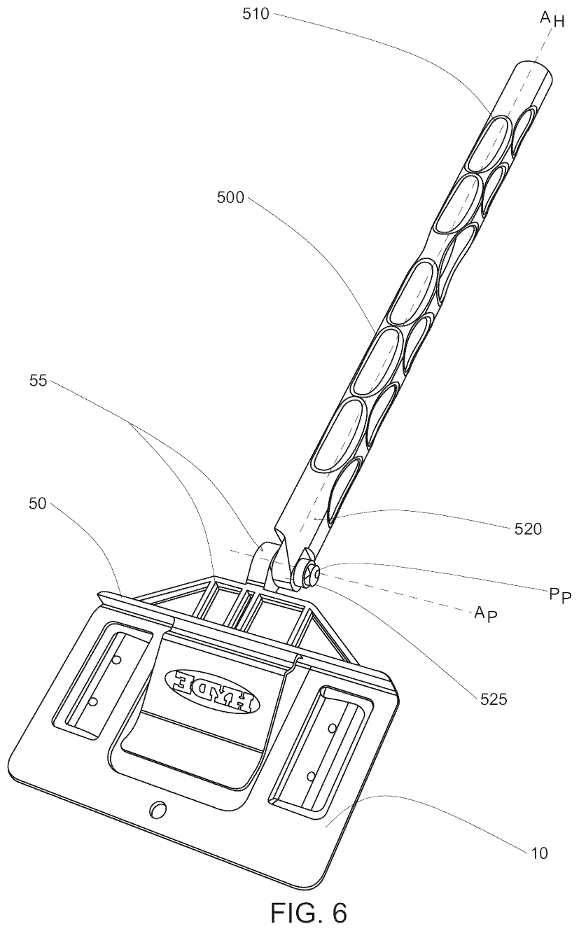

As indicated in the summary, and now described with principal reference to FIG. 6, and secondary reference to FIGS. 1-5, the spray shield holder 10 may be attached to a handle 500. In FIG. 6, the spray shield holder 10 is illustratively attached to an elongated handle 500 extending longitudinally along a handle axis A_{H} between handle proximate and distal ends 510 and 520. The spray shield holder 10 includes a handle coupling 55 depending from the platform proximate edge 50 from which it extends rearwardly of the platform 20. The handle coupling 55 facilitates attachment of the spray shield holder 10 to a platform coupling 525 at the handle distal end 520. The handle and platform couplings 55 and 525 are connected to one another by a pivot pin P_{P}, thereby enabling pivotal motion of the platform 10 relative to the handle 500 about a pivot axis A_{P}.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A spray shield holder, comprising:
a substantially rectangular platform defining opposed first and second spray-shield mounting surfaces that coextend between a platform proximate edge by which the platform can be held by a user, a platform distal edge forward of the proximate edge, and platform lateral first and second edges that extend between the platform proximate and distal edges, the first and second spray-shield mounting surfaces furthermore defining, respectively, first and second spray-shield mounting planes;
a central clip carried by the platform and having a central-clip rearward end by which the central clip depends from the platform, a central-clip forward end, and lateral central-clip first and second edges that extend between the central-clip rearward and forward ends, the central-clip forward end and the first and second edges being free from the platform such that the central-clip forward end can be selectively displaced toward and away from the first spray-shield mounting plane in order to accommodate the removable retention of a central spray-shielding substrate between the central clip and the first spray-shield mounting surface; and
a lateral first clip situated between the central clip and the lateral first edge of the platform, the first clip having a first-clip fixed end by which it depends from the platform, a first-clip free end laterally opposite the first-clip fixed end and situated between the first-clip fixed end and the lateral first edge of the platform, and first-clip front and rear edges that extend between the first-clip fixed and free ends, the first-clip free end and front and rear edges being free from the platform such that the first-clip free end can be selectively displaced toward and away from the second spray-shield mounting plane in order to accommodate the removable retention of a first spray-shielding substrate between the first clip and the second spray-shield mounting surface, wherein
(a) the central-clip forward end is normally mechanically biased toward the first mounting plane such that a central spray-shielding substrate introduced between the central clip and the first spray-shield mounting surface is retained therebetween by action of the central-clip forward end's contacting engagement with the central spray-shielding substrate and mechanical bias toward the first spray-shield mounting surface; and
(b) the first-clip free end is normally mechanically biased toward the second mounting plane such that a first spray-shielding substrate introduced between the first clip and the second spray-shield mounting surface is retained therebetween by action of the first-clip free end's contacting engagement with the first spray-shielding substrate and mechanical bias toward the second spray-shield mounting surface.

2. The spray shield holder of claim 1 further comprising a lateral second clip situated between the central clip and the lateral second edge of the platform, the second clip having a second-clip fixed end by which it depends from the platform, a second-clip free end laterally opposite the second-clip fixed end and situated between the second-clip fixed end and the lateral second edge of the platform, and second-clip front and rear edges that extend between the second-clip fixed and free ends, the second-clip free end and front and rear edges being free from the platform such that the second-clip free end can be selectively displaced toward and away from the second spray-shield mounting plane in order to accommodate the removable retention of a second spray-shielding substrate between the second clip and the second spray-shield mounting surface, wherein
the second-clip free end is normally mechanically biased toward the second mounting plane such that a second spray-shielding substrate introduced between the second clip and the second spray-shield mounting surface is retained therebetween by action of the second-clip free end's contacting engagement with the second spray-shielding substrate and mechanical bias toward the second spray-shield mounting surface.

3. The spray shield holder of claim 2 wherein
(a) the central-clip forward end extends substantially parallel to the platform distal edge; and
(b) the first-clip and second-clip free ends extend substantially orthogonal to the platform distal edge, such that the first-clip and second-clip free ends extend substantially parallel to one another and substantially perpendicular to the central-clip forward end.

4. The spray shield holder of claim 3 wherein the central, first, and second clips are integrally formed with the platform from which they depend.

5. The spray shield holder of claim 4 wherein (a) the platform and the central, first, and second clips are fabricated from the same material;
(b) the platform is of a thickness and configuration that renders it substantially rigid; and
(c) each of the central, first, and second clips has a default configuration from which it can be flexedly deformed, through application of an external flexing force, in a direction away from the platform in order to accommodate the introduction and retention of a spray-shielding substrate between that clip and the platform, the deformation of the clip in each case causing that clip to exert a biasing force toward both the platform and that clip's default configuration.

6. The spray shield holder of claim 5 further comprising a handle coupling that facilitates attachment of a handle by which a user can holder the spray shield holder.

7. The spray shield holder of claim 6 wherein the handle coupling depends from the proximate edge of the platform and facilitates pivotal motion of the platform relative to the handle about at least a first pivot axis.

8. A spray shield holder, comprising:
a substantially rigid platform having opposed first and second spray-shield mounting surfaces that coextend between a platform proximate edge, a platform distal edge forward of the proximate edge, and platform lateral first and second edges that extend between the platform proximate and distal edges;
a forward-facing central clip depending from the first spray-shield mounting surface;
a lateral first clip depending from the second spray-shield mounting surface, and situated and facing laterally to the outside of the central clip; and
a lateral second clip depending from the second spray-shield mounting surface, and situated and facing laterally to the outside of the central clip opposite the side of the central clip on which the lateral first clip is located, wherein
(a) the central clip is configured for removably retaining a central spray shield; and
(b) the lateral first and second clips are configured for removably retaining, respectively, first and second spray shields on mutually opposite lateral sides of the central clip.

9. The spray shield holder of claim 8 wherein
(a) the central, first, and second clips are fabricated from the same material as, and integrally formed with, the platform from which they depend; and
(b) each of the central, first, and second clips has a default configuration from which it can be flexedly deformed, through application of an external flexing force, in a direction away from the platform in order to accommodate the introduction and retention of a spray-shielding substrate between that clip and the platform, the deformation of the clip in each case causing that clip to exert a biasing force toward both the platform and that clip's default configuration.

10. The spray shield holder of claim 9 further comprising a handle coupling that (a) depends from the proximate edge of the platform, (b) facilitates attachment of a handle by which a user can holder the spray shield holder, and (c) facilitates pivotal motion of the platform relative to the handle about at least a first pivot axis.

11. The spray shield holder of claim 8 further comprising a handle coupling that (a) depends from the proximate edge of the platform, (b) facilitates attachment of a handle by which a user can holder the spray shield holder, and (c) facilitates pivotal motion of the platform relative to the handle about at least a first pivot axis.

12. A spray shield holder, comprising:
a substantially rigid platform having opposed first and second spray-shield mounting surfaces that coextend between a platform proximate edge, a platform distal edge forward of the proximate edge, and platform lateral first and second edges that extend between the platform proximate and distal edges;
a forward-facing central clip depending from the first spray-shield mounting surface; and
a lateral first clip depending from the second spray-shield mounting surface, and situated and facing laterally to the outside of the central clip, wherein
(a) the central clip is configured for removably retaining a central spray shield; and
(b) the lateral first clip is configured for removably retaining a first spray shield laterally to the outside of the central clip.

13. The spray shield holder of claim 12 wherein
(a) the central and first clips are fabricated from the same material as, and integrally formed with, the platform from which they depend; and
(b) each of the central and first clips has a default configuration from which it can be flexedly deformed, through application of an external flexing force, in a direction away from the platform in order to accommodate the introduction and retention of a spray-shielding substrate between that clip and the platform, the deformation of the clip in each case causing that clip to exert a biasing force toward both the platform and that clip's default configuration.

14. The spray shield holder of claim 13 further comprising a handle coupling that (a) depends from the proximate edge of the platform, (b) facilitates attachment of a handle by which a user can holder the spray shield holder, and (c) facilitates pivotal motion of the platform relative to the handle about at least a first pivot axis.

15. The spray shield holder of claim 13 further comprising a handle pivotably attached to the platform through the handle coupling.

16. The spray shield holder of claim 12 further comprising a handle coupling that (a) depends from the proximate edge of the platform, (b) facilitates attachment of a handle by which a user can holder the spray shield holder, and (c) facilitates pivotal motion of the platform relative to the handle about at least a first pivot axis.

17. The spray shield holder of claim 13 further comprising an elongated handle pivotably attached to the platform through the handle coupling.
